(19) United States
(12) Patent Application Publication
(10) Pub. No.: US 2016/0252021 A1
(43) Pub. Date: Sep. 1, 2016

(54) A VALVE TRAIN ASSEMBLY

(71) Applicant: EATON SRL, Torino (IT)

(72) Inventors: Majo CECUR, Rivarolo Canavese (IT); Marco ALESSANDRIA, Trana (TO) (IT); Emanuele RAIMONDI, San Francesco Al Campo (TO) (IT)

(21) Appl. No.: 15/028,031

(22) PCT Filed: Oct. 7, 2014
(86) PCT No.: PCT/EP2014/071459

§ 371 Date: Apr. 8, 2016

(30) Foreign Application Priority Data
Oct. 9, 2013 (GB) 1317877.7

(51) Int. Cl. F02D 13/06; F02D 13/02; F01L 1/344

(52) U.S. Cl. CPC F02D 13/06; F01L 1/344; F02D 13/0203

(57) ABSTRACT

A valve train assembly for operating a first valve of a first cylinder of an internal combustion engine has a rotatable earn shaft having a cam arrangement axially movable along the cam shaft so that the valve train assembly is selectively configurable in a first configuration and a second configuration. In use, when the valve train assembly is in the first configuration the first valve of the first cylinder is operated in response to the first cam arrangement as the cam shaft rotates to provide a corresponding valve event in each of a plurality of successive cylinder cycles, and when the valve train assembly is in the second configuration the first valve of the first cylinder is operated in response to the first cam arrangement as the cam shaft rotates to provide a corresponding valve event in every other cylinder cycle of a plurality of successive cylinder cycles.

### CROSS-REFERENCE TO RELATED APPLICATIONS

This application is a U.S. national stage application under 35 U.S.C. §371 of International Application No. PCT/EP2014/071459, filed on Oct. 7, 2014, and claims benefit to British Patent Application No. 1317877.7, filed on Oct. 9, 2013. The International Application was published in English on Apr. 16, 2015, as WO 2015/052196 A1 under PCT Article 21(2).

### FIELD

The present invention relates to a valve train assembly.

### BACKGROUND

Cylinder deactivation systems for deactivating selected cylinders of an internal combustion engine by deactivating the intake and exhaust valves of those cylinders depending upon prevailing engine operating conditions (typically cylinders are deactivated during light load operation) are known.

One type of known cylinder deactivation system comprises a valve train which, for each engine cylinder to be deactivated, comprises a lost motion component for the intake valve(s) of that cylinder and a lost motion component for the exhaust valve(s) of that cylinder. When cylinder deactivation mode is activated, the lost motion components are activated, and consequently valve lifts that otherwise would have occurred in response to the rotation of intake and exhaust cams are instead absorbed as ‘lost motion’ within the respective lost motion components. Accordingly, the valves remain closed and their respective cylinders are inactive.

In traditional cylinder deactivation systems for internal combustion engines that comprise an even number of engine cylinders, ½ of the cylinders in the engine are configured for deactivation and ½ are not. When in cylinder deactivation mode, the ½ of the cylinders that are configured for deactivation are deactivated while the remaining cylinders continue to function normally. This type of cylinder deactivation arrangement is not ideal for engines that comprise an odd number of cylinders. For example, in the case of a 3 cylinder engine, when in cylinder deactivation mode, it would not be ideal to have one of those cylinders deactivated while the other two continued to function normally. Cam-less cylinder deactivation systems are known which are suitable for odd cylinder numbered engines and which enable each cylinder to be deactivated and then reactivated from cycle to cycle (so that in deactivation mode no individual cylinder is continually deactivated) but such systems are complicated.

### SUMMARY

An aspect of the invention provides a valve train assembly for operating a first valve of a first cylinder of an internal combustion engine, the valve train assembly comprising: a rotatable cam shaft including a cam arrangement, wherein the cam arrangement is axially movable along the rotatable cam shaft so that the valve train assembly is selectively configurable in a first configuration and a second configuration. In use, when the valve train assembly is in the first configuration, the first valve of the first cylinder is operated in response to the first cam arrangement as the rotatable cam shaft rotates to provide a corresponding valve event in each of a plurality of successive cylinder cycles. In use, when the valve train assembly is in the second configuration, the first valve of the first cylinder is operated in response to the first cam arrangement as the rotatable cam shaft rotates to provide a corresponding valve event in every other cylinder cycle of a plurality of successive cylinder cycles.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic perspective view of components of an internal combustion engine including a valve train assembly;

FIG. 2 illustrates a cam arrangement;

FIG. 3 is a schematic side view of the internal combustion engine of FIG. 1 with the valve train assembly in a first configuration;

FIG. 4 is a schematic side view of the internal combustion engine of FIG. 1 with the valve train assembly in a second configuration;

FIG. 5 is a schematic illustration of a firing sequence of three engine cylinders of an internal combustion engine;

FIG. 6 is a schematic perspective sectional view the internal combustion engine of FIG. 1;

FIG. 7 illustrates a retention pin;

FIG. 8 is a schematic side sectional view of a camshaft;

FIG. 9 is a perspective view of an actuator rod;

FIG. 10 is a side sectional view of the actuator rod of FIG. 9;

FIG. 11 is a schematic side sectional view of a valve train assembly in a first configuration; and

FIG. 12 is a schematic side sectional view of the valve train assembly in a second configuration.

### DETAILED DESCRIPTION

It is desirable to provide an improved valve train assembly that can provide a cylinder deactivation function, in particular, but not exclusively, in an engine comprising an odd number of cylinders.

According to an aspect of the invention, there is provided a valve train assembly for operating a first valve of a first cylinder of an internal combustion engine, the valve train assembly comprising; a rotatable cam shaft having a cam arrangement; wherein, the cam arrangement is axially movable along the cam shaft so that the valve train assembly is selectively configurable in a first configuration and a second configuration; wherein, in use, when the valve train assembly is in the first configuration the first valve of the first cylinder is operated in response to the first cam arrangement as the cam shaft rotates to provide a corresponding valve event in each of a plurality of successive cylinder cycles, and when the valve train assembly is in the second configuration the first valve of the first cylinder is operated in response to the first cam arrangement as the cam shaft rotates to provide a corresponding valve event every other cylinder cycle of a plurality of successive cylinder cycles.

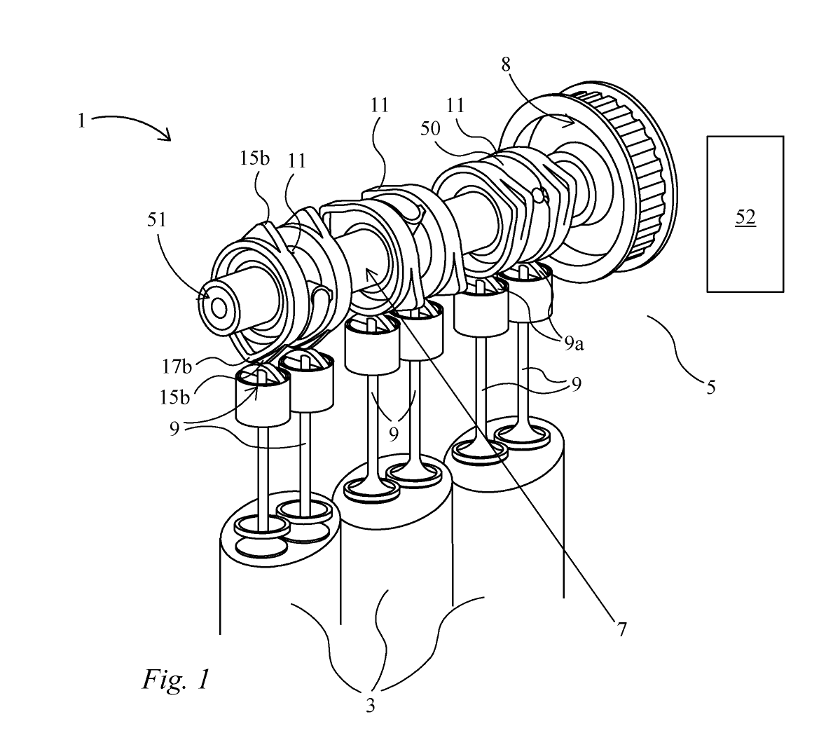

FIG. 1 is a schematic illustration of part of an internal combustion engine 1. In this example the engine 1 is a three cylinder engine comprising three cylinders 3. A valve train assembly 5 of the Overhead Camshaft (OHC) type comprises a camshaft 7 for operating three pairs of valves 9 wherein each of the pairs of valves 9 is for a respective one of the three cylinders 3. The valves 9 are either all intake valves or all exhaust valves. Each valve comprises a return spring biased to return that valve to a closed positions after it has been opened. It will be appreciated that whatever type of valves the valves 9 are (i.e. intake or exhaust), the engine 1 will comprise a second camshaft, similar to the camshaft 7, for operating three corresponding pairs of the other type valves, one pair of valves for each cylinder 3. Accordingly, each cylinder 3 comprises a pair of intake valves and a pair of exhaust valves. The camshaft 7 comprises a camshaft pulley 8 at one end connected by gearing to an engine crankshaft (not shown) so that in use crankshaft rotation causes rotation of the camshaft 7.

The camshaft 7 comprises three cam assemblies 11 mutually spaced apart along a longitudinal axis of the camshaft 7. Each cam assembly 11 is for controlling a respective one of the three pairs of valves 9. To this end, each valve comprises at its upper end a lifting pad 9a arranged to be in sliding engagement with a cam assembly 11 as the camshaft 7 rotates. As will explained in greater detail below each cam assembly 11 is rotationally locked with respect to the camshaft 7 (i.e. when the camshaft 7 and hence each cam assembly 11 rotate, there is no relative rotation between the camshaft 7 and each cam assembly 11) but the cam assemblies 11 are shift-able along the longitudinal axis of the camshaft 7 between a first position that provides for a normal engine combustion mode and a second position that provides for a cyclical cylinder deactivation mode.

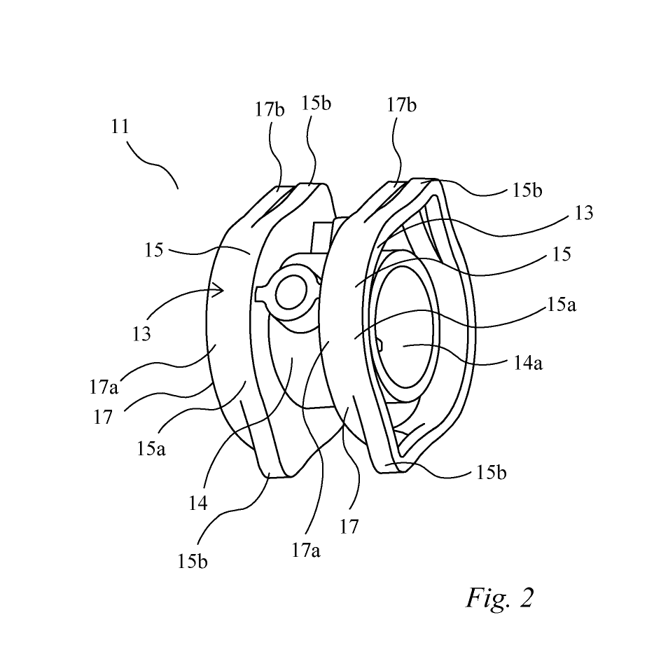

Referring now to FIG. 2 in particular, each cam assembly 11 defines first and second cam sections 13, one at each respective end of the cam assembly 11, separated by a central section 14. Each cam assembly 11 defines a central bore 14a extending along its longitudinal axis and through which, when the valve train assembly 3 is assembled, the cam shaft 7 extends.

Each cam section 13 further defines first 15 and second 17 cams arranged side-by-side along the axis of cam assembly 11. Each first cam 15 comprises a base circle 15a and a pair of lift lobes 15b. In this example, the lift lobes 15b are identical and have an angular separation of 180 degrees. Each second cam 17 defines a base circle 17a and a single lift lobe 17b. The lift lobe 17b may have a different profile to the lift lobes 15b.

When the cam assemblies 11 are in the first position that provides for normal engine combustion mode each first cam 15 is positioned so that it is in sliding contact with its respective one of the lifting pads 9a of a valve 9 and each second cam 17 is positioned so that it is not in contact that respective one of the lifting pads 9a. In contrast, when the cam assemblies 11 are in the second position that provides for cylinder deactivation mode, it is each second cam 17, rather than each first cam 15, that is positioned so that it is in sliding contact with its respective one of the lifting pads 9a of a valve 9.

It will be appreciated that in standard internal combustion engines comprising camshaft systems, a complete four stroke engine cycle of a cylinder comprises two complete rotations (i.e. 720 degrees) of the engine's crankshaft and one rotation (i.e. 360 degrees) of the camshaft (and thus the crankshaft is connected to drive a camshaft at half its own rate of rotation). Typically, each cam comprises a single main lift lobe so that the engine valve controlled by that cam is actuated once per engine cycle.

In contrast, in this example, the engine crankshaft (not shown) is connected to the cam pulley 8 by gearing so as to drive the camshaft 7 at one quarter of the crankshaft's own rate of rotation so that a complete four stroke engine cylinder cycle comprises two complete rotations of the engine's crankshaft (as per normal) but only one half of a rotation (i.e. 180 degrees) of the camshaft 7.

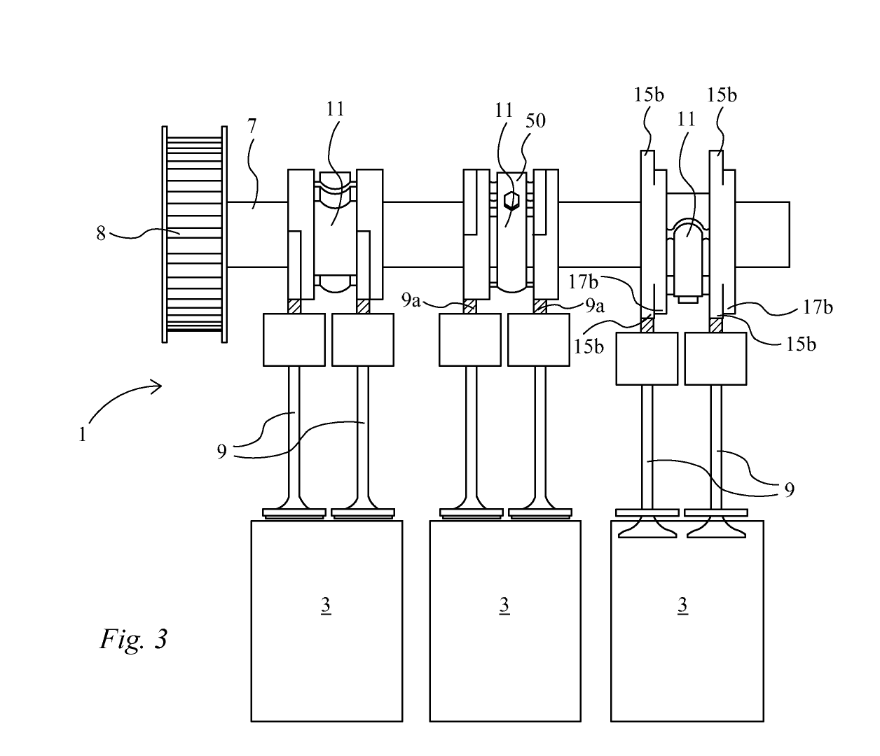

Accordingly, when the cam assemblies 11 are in the first position that provides for a normal engine combustion mode (FIG. 3), even though the camshaft 7 is rotating at half the normal rate of a camshaft, each valve 9 is still operated once per engine cycle by virtue of each first cam 15 having two first lift lobes 15b at 180 degrees separation. However, for a given first cam 15 of a cam assembly 11, the particular one of the two first lift lobes 15b that activates a valve 9 in a given engine cycle of a cylinder 3 alternates from cycle to cycle.

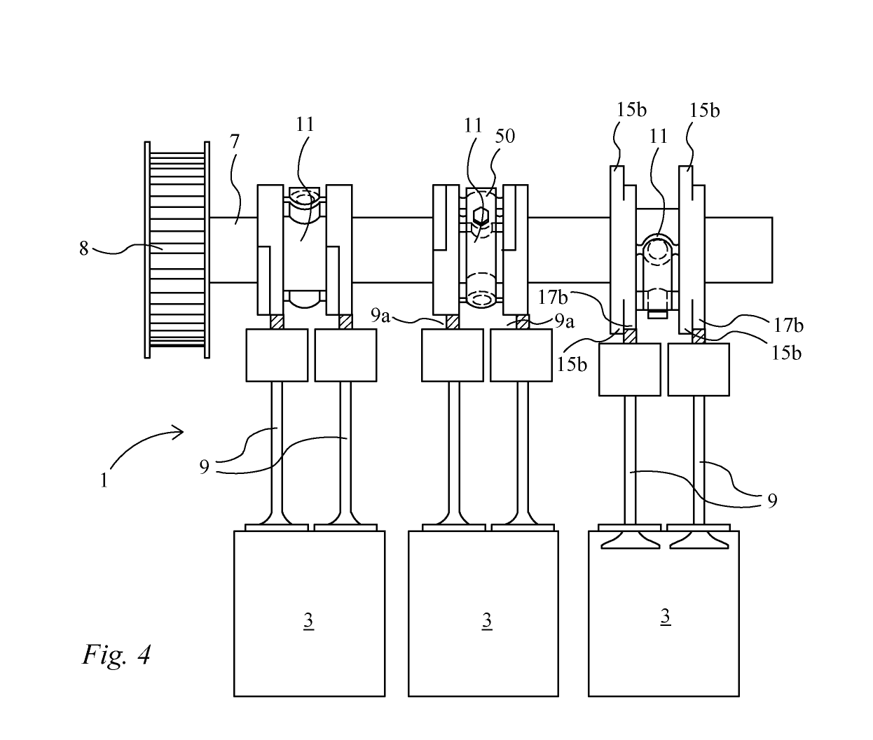

When the cam assemblies 11 are in the second position (FIG. 4), the two second cams 17 of the cam assembly 11 of a given cylinder 3 activate the two valves 9 of that cylinder only once every other cylinder engine cycle because the camshaft 7 is rotating at a ¼ the rate of the crankshaft and each second cam 17 comprises only a single lobe 17b, but do not activate the valves 9 in each cycle that falls between successive active cycles. During those engine cycles in which the cylinder 3 is de-activated, the base circles 17a of the second cams 17 remain in sliding contact with their respective valves 9 for the whole of the engine cycle and hence the valves 9 remain closed.

It will be appreciated that preferably, if each single lobe 17b is shaped differently from each lobe 15b and/or angularly offset from the lobe 17b that it is closest to, the valve lift for each cylinder that is provided in the deactivation mode will be different (in height and/or timing) from the valve lift for each cylinder that is provided in the normal combustion mode and can be made more suitable for the lower engine speeds and loads associated with the deactivation mode.

In this example, the cylinders 3 have a known so called 1-2-3 firing order (i.e. a sequence of power delivery of the cylinders). Accordingly, the lift lobes of each cam arrangement 11 are angularly offset with respect to the corresponding lift lobes of the other two cam arrangements 11 so that the timing of the various valve events is appropriate for the cylinder firing order.

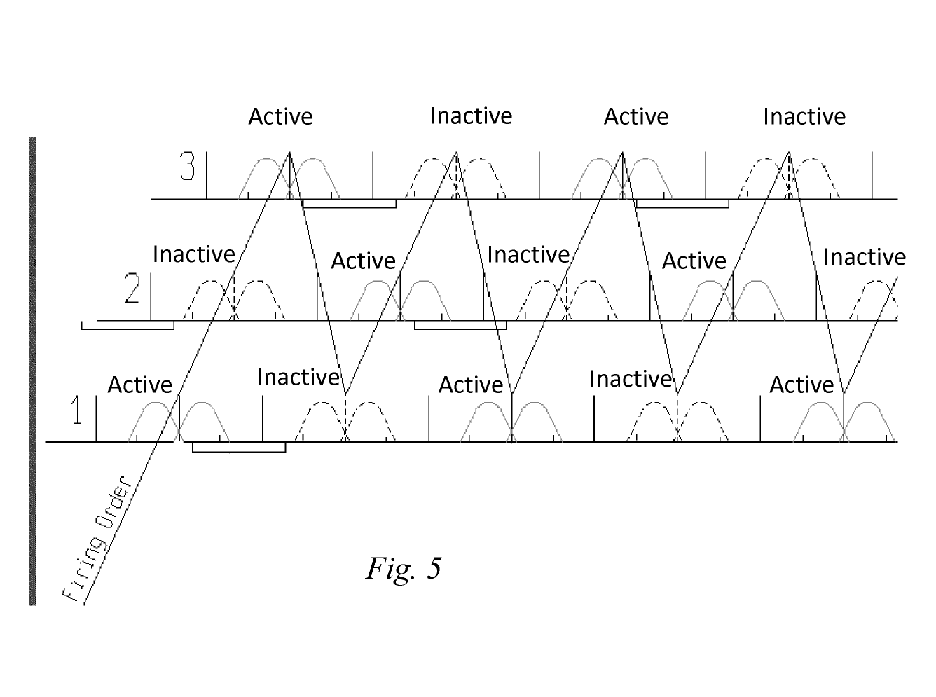

FIG. 5 illustrates schematically a firing sequence for the three cylinders (individually labelled 1, 2 and 3 in FIG. 5) and further indicates for each of the three cylinders which of its engine cycles is active and which is de-active when the valve train assembly 5 is the second configuration. Each active cycle is indicated by two full line curves (one representing the valve lift of an intake valve, the other the valve lift of an exhaust valve) and each in-active cycle is indicated by two broken line curves. Looked at individually, it can be seen that, as described above, for a given cylinder, every other engine cycle is active with successive active cycles being separated by an inactive cycle. For cylinders 1 and 3 (as labelled in the Figure) odd numbered cycles are active and even numbered cycles are inactive and vice versa for the cylinder labelled 2. As the cylinders are fired in the repeating sequence 1-2-3, the net overall repeating sequence for the three cylinders in combination is 1(active)-2(inactive)-3(active)-1(inactive)-2(active)-3(inactive) with the result that engine torque remains well balanced because every active cycle in the firing sequence is followed by an inactive cycle and vice versa. Moreover, in contrast with cam-less cylinder deactivation systems, this result is achieved in a straightforward manner simply by placing the valve train assembly into the second configuration. There is no requirement for a solenoid (or other such control system) for each valve (or pair of valves) for repeatedly activating and deactivating the valve(s) from cycle to cycle.

It will be appreciated that within two cam revolutions each cylinder is activated once and deactivated once and in effect the 3 cylinder engine is running in a 1.5 cylinder mode.

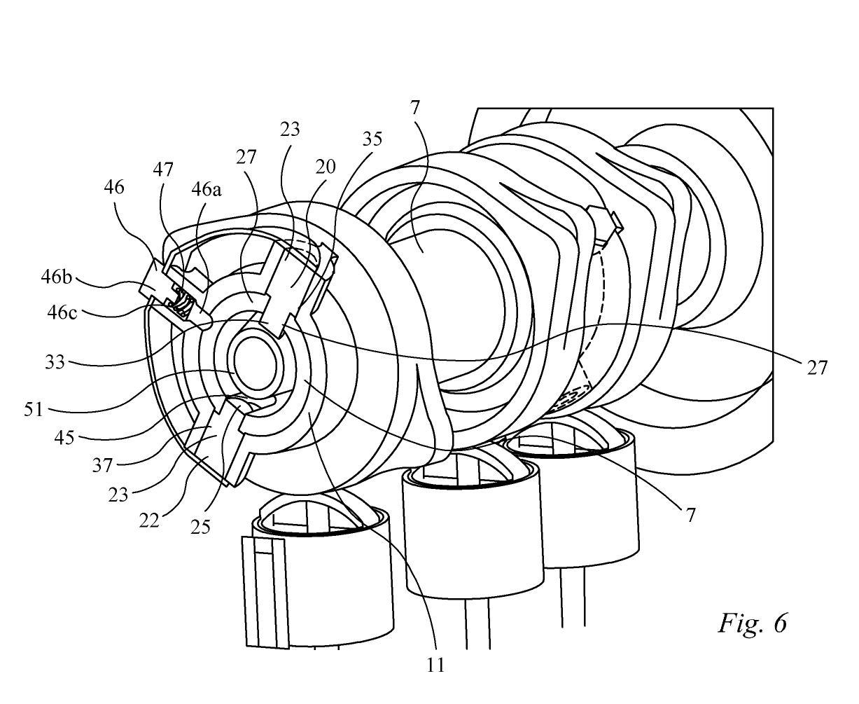

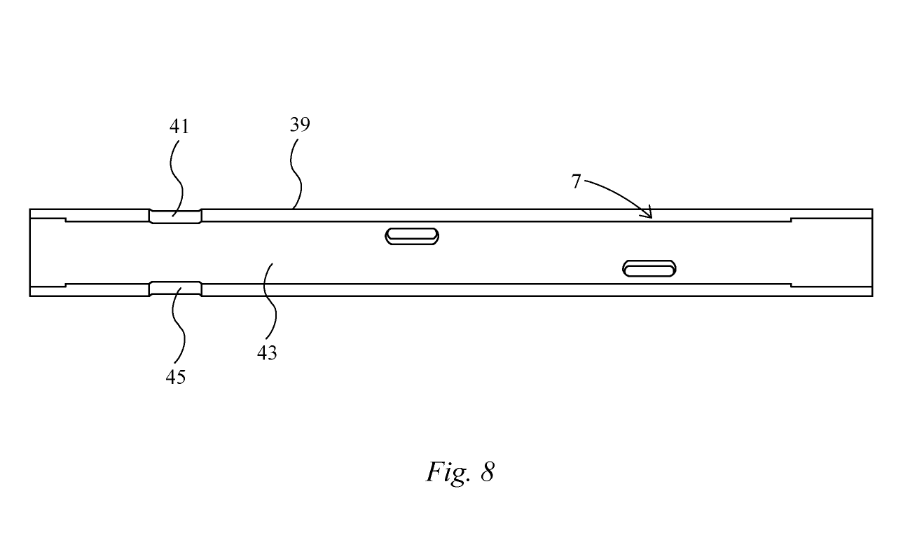

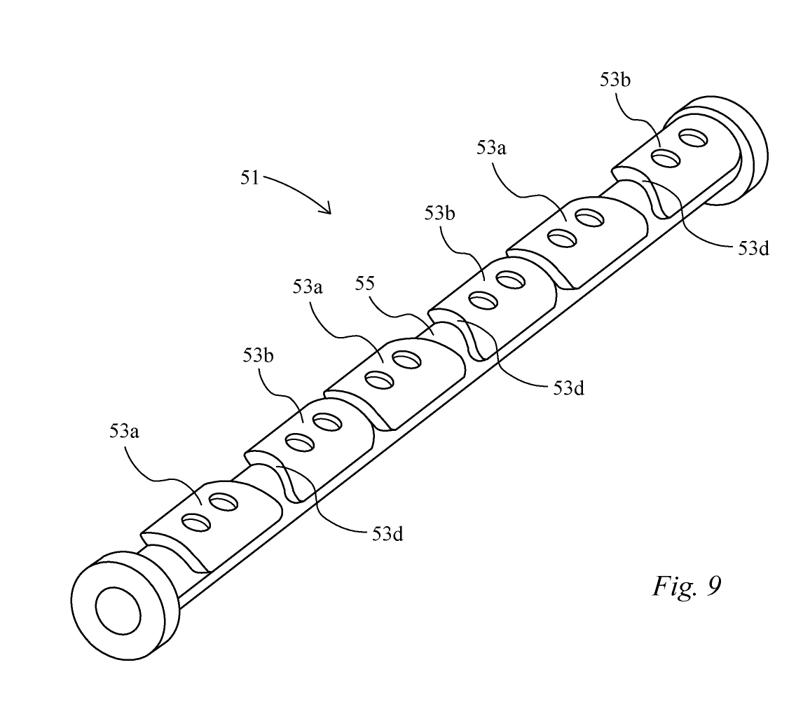

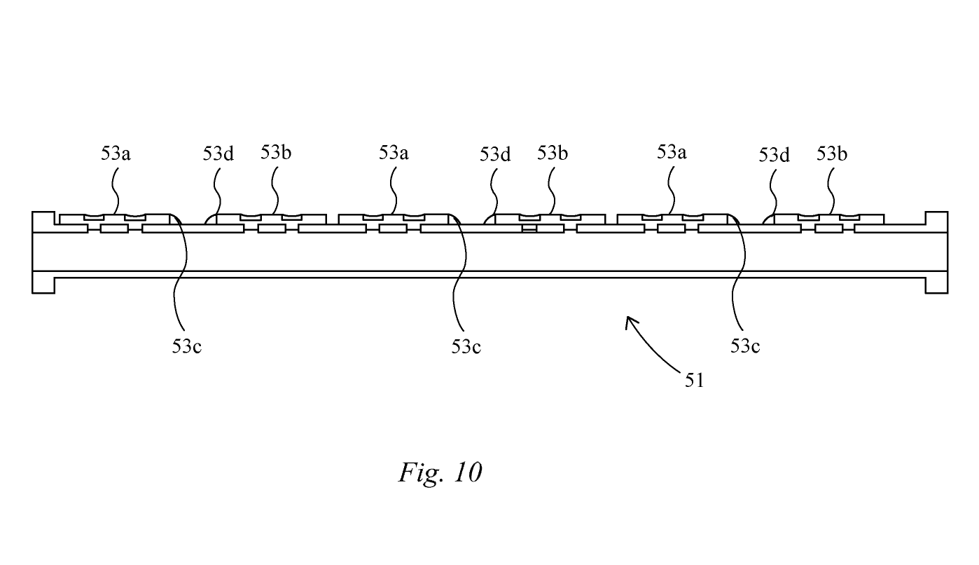

Referring now primarily to FIGS. 6 to 12 there is described an example actuation system for axially shifting the cam assemblies 11 so as to configure the valve train assembly 5 between the first configuration and the second configuration.

In this example, each cam assembly 11 comprises first 20 and second 22 retention pins which prevent relative rotation between that cam assembly 11 and the camshaft 7 but allow that cam assembly 11 to move axially along the camshaft 11 between the first and second positions.

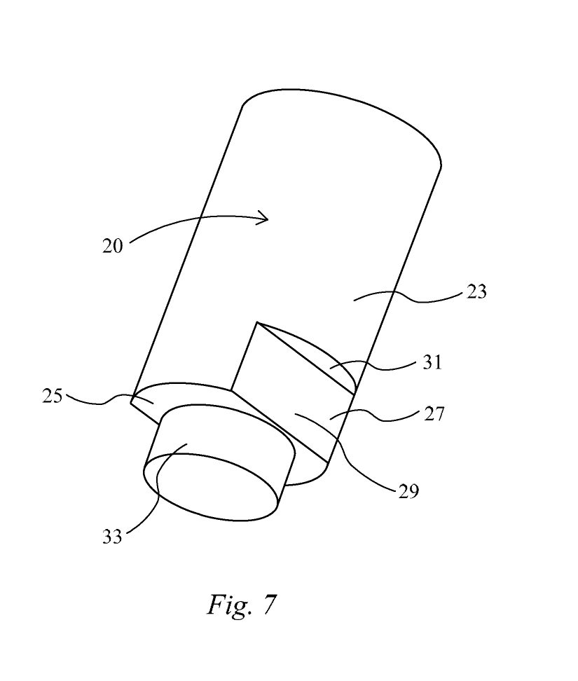

As seen in FIG. 7, the first retention pin 20 comprises a first cylindrical portion 23 defining towards a first end surface 25 a pair of cut out shoulder sections 27 (only one is visible in the view of FIG. 7). Each cut out section 27 comprises a first planar contact surface 29 and a second planar contact surface 31. The first planar contact surface 27 is perpendicular to and intersects the first end surface 25 and the second planar contact surface 31 is parallel to the first end surface 25 and intersects the first planar contact surface 27. The first retention pin 20 further comprises a second cylindrical portion 33 which is coaxial with the first cylindrical portion 23 and extends from the first end surface 25. The second cylindrical portion 33 has a smaller diameter and a smaller length than the first cylindrical portion 23.

The second retention pin 22 is similar to the first retention pin 20 but does not comprise a second cylindrical portion 33.

In each cam assembly 11, the first retention pin 20 is received within a first aperture 35 defined by the cam assembly 11 and the second retention pin 22 is received within a second aperture 37 also defined by the cam assembly 11. The first retention pin 20 fits tightly in the first aperture 35 with the second planar contact surfaces 31 resting on an outer surface 39 of the camshaft 7 and the first planar contact surfaces 27 in contact with the side walls of a first guide slot 41 defined in the cam shaft 7. The end surface 25 of the first retention pin 20 is flush with the inner surface 43 of the camshaft 7 and the second cylindrical portion 33 extends into the hollow interior of the camshaft 7.

Similarly, the second retention pin 22 fits tightly in the second aperture 37 with the second planar contact surfaces 31 resting on the outer surface 39 of the camshaft 7 and the first planar contact surfaces 27 in contact with the side walls of a second guide slot 45 defined in the cam shaft 7. The end surface 25 of the second retention pin 22 is flush with the inner surface 43 of the camshaft 7 but, as there is no second cylindrical portion 33, no part extends into the hollow interior of the camshaft 7.

Thus, the rotational position of a cam assembly 11 relative to the camshaft 7 is fixed (to be non-rotatable) while a degree of axial sliding movement of the cam assembly 11 relative to the camshaft 7 is permitted.

Each cam assembly 11 further comprises an axial position positioning pin 46 received within a third aperture 47 defined by the cam assembly 11. Each positioning pin 46 comprises a tip portion 46a, a head portion 46b and a biasing member 46c disposed between the two. For each cam assembly 11, the camshaft 7 is provided with first 48 and second 49 formations on its outer surface 39 which respectfully precisely define the first and second axial positions of the cam assembly 11. The tip portion 46a of each positioning pin 46 is complimentary in shape to the first 48 and second 49 formations so that when a cam assembly 11 is in the first position its positioning pin 46 engages the first formation 47 and when the cam assembly 11 is in the second position its positioning pin 46 engages the second formation 49. The biasing member 46c of each positioning pin 46 is arranged to bias its tip 46c towards the outer surface 39 of the camshaft 7 so that the positioning pin 46 functions to retain its cam assembly 11 in its axial position when in either the first position or the second position. In this way, a positioning pin 46 inhibits a cam assembly 11 from being accidently moved out of the first or second positions.

In this example, for a given cam assembly 11, the first retention pin 20, the second retention pin 22 and the positioning pin 46 are held in position in that cam assembly 11 by means of a clip 50 that is attached around the central section 14 of the cam assembly.

It will be appreciated that for a given cam assembly 11, the first guide slot 41, the second guide slot 45, the first formation 48 and the second formation 49 formed in the cam shaft 7 for that assembly 11 are angularly offset around the circumference of the cam shaft 11 with respect to those corresponding slots and formation for the other cam assemblies 11. This enables the cam assemblies 11 to be fitted to the cam shaft 11 with the required angular offset of the corresponding lift lobes of the cam arrangements 11 required to provide the various valve events appropriate for the cylinder firing order.

An actuation rod 51 which is co-axial with and fitted inside the camshaft 7 is provided for moving the cam assemblies 11 between the first and second positions and to this end is driven by an actuator 52 (See FIG. 1). The actuation rod 51 comprises three pairs of raised portions 53a, 53b spaced apart axially on its outer surface 55, each pair comprising a first raised portion 53a and a second raised portion 53b. Each first raised portion 53a and second raised portion 53b of a pair comprises respective first 53c and second 53d push surfaces. The pairs of raised portions 53a and 53b are positioned along the actuation rod 51 so that each corresponding pair of first 53c and second 53d push surfaces define a region through which the second cylindrical portion 33 of a first retention pin 20 of a cam assembly 11 is free to pass through as the cam shaft 11 rotates (the actuation rod 51 itself does not rotate). The first 53c and second 53d contact surfaces each tapers in height along its length and for a given pair of opposing first 53c and second 53d contact surfaces, the first 53c and second 53d contact surfaces are angled across the surface of the actuation rod 51 in opposite senses so that at one end the first 53c and second 53d contact surfaces are closer together than they are at the other end. It will be appreciated that as the cam shaft 11 rotates, each second portion 33 enters a region at end at which the first 53c and second 53d contact surfaces are furthest apart and leaves the region at the end at which the first 53c and second 53d contact surfaces are closet together.

As illustrated, each first raised portion 53a and each second raised portion 53b may be non-integral with the actuation rod 51 and may be fixed to the actuation rod 51 by some suitable means (e.g. snap-fitted). Alternatively, each first raised portion 53a and each second raised portion 53b may be formed integrally the actuation rod 51.

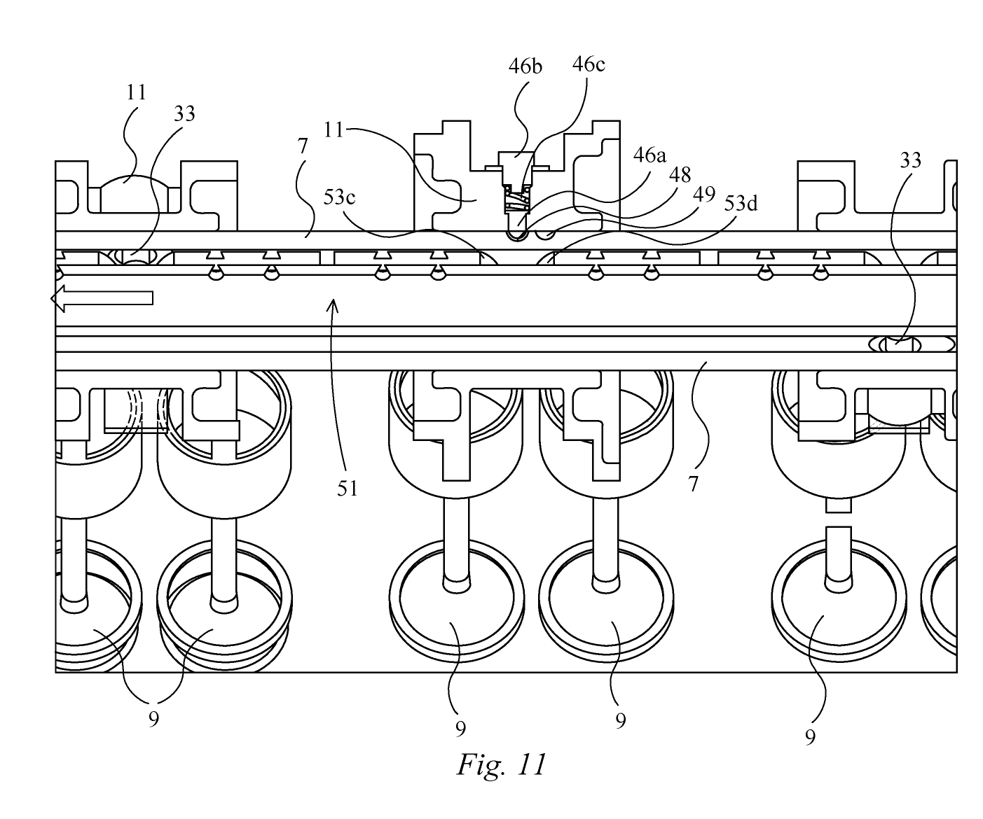

As illustrated in FIG. 11, when in the first non-deactivating position, the positioning pin 46 of each cam assembly 11 engages a first formation 48 to help retain that cam assembly 11 in position as the cam shaft 7 (and cam assemblies 11) rotates about it axis. In order to shift the cam assemblies 11 from the first position to the second position, the actuator shifts the actuation rod 51 axially (to the right as viewed in the plane of FIG. 11) by a fixed amount which brings each first 53c surface into contact with a second cylindrical portion 33 of a first retention pin 20 so that the actuation rod 51 exerts a pushing force on the cam assemblies 11 causing the positioning pins 46 to disengage from the first formations 48 and the cam assemblies 11 to slide axially across the cam shaft 7 until the cam assemblies 11 are in the second position and under the action of the biasing members 45c the positioning pins 45 have engaged the second formations 49.

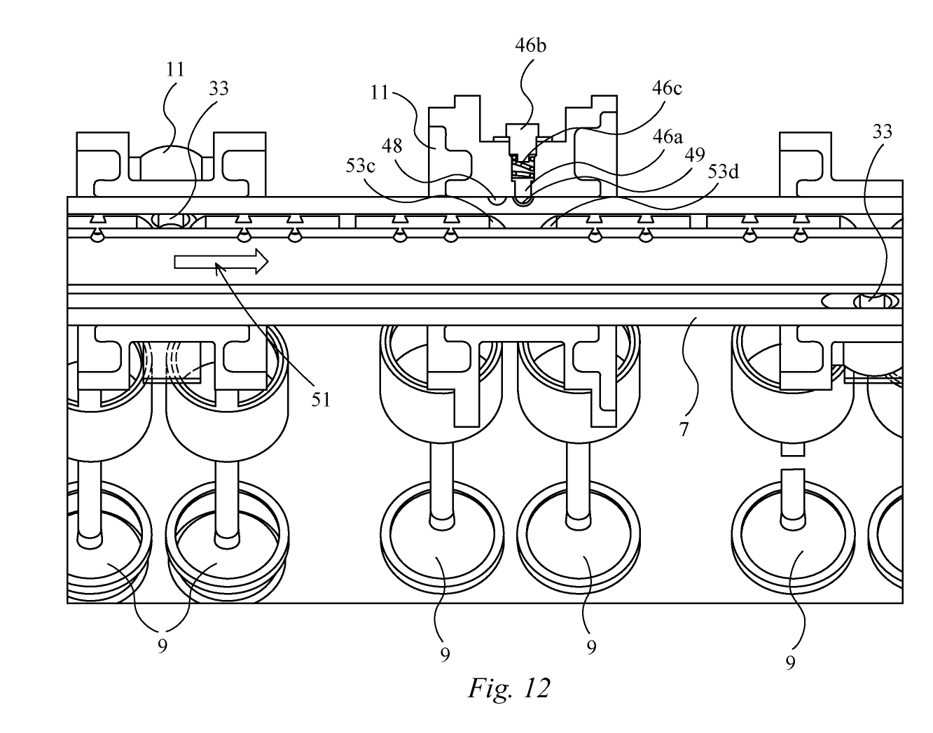

Similarly, in order to shift the cam assemblies 11 from the second position to the first position, the actuator shifts the actuation rod 51 axially in the reverse direction (to the left as viewed in the plane of FIG. 12) by the fixed amount which brings each second 53d surface into contact with a second cylindrical portion 33 of a first retention pin 20 so that the actuation rod exerts a pushing force on the cam assemblies 11 causing the positioning pins 46 to disengage from the second formations 49 and the cam assemblies 11 to slide axially across the cam shaft until the cam assemblies 11 are in the first position and under the action of the biasing members the positioning pins 46 have engaged the first formations 48. It will be appreciated that the actuation rod may have stopped moving before contact with it causes the cam assemblies to move. It will further be appreciated that in dependence upon the relative angular positions of the retentions pins 20, the cam assemblies will be caused to be moved in a sequence that correspond with the firing sequence of the cylinders (e.g. for a firing sequence 1-2-3, the cam assembly for cylinder 1 moves first, then that of cylinder 2, then that of cylinder 3).

Accordingly, the actuation system provides a simple and reliable system for configuring the valve train assembly in the first and second configurations.

The above embodiments are to be understood as illustrative examples of the invention only. Further embodiments of the invention are envisaged. For example, although in the described embodiments each cam assembly 11 is for operating a pair of cylinder valves 9, in alternative embodiments each cam assembly 11 may be arranged to operate a single cylinder valve 9 or more than two cylinder valves 9. Although in the described embodiment the valve train assembly 3 is for a three cylinder engine and hence is provided with three cam assemblies 11, in alternative embodiments the valve assembly 3 may be arranged for use in an engine having a different number of cylinders than three and be provided with an appropriate number of cam assemblies 11. It will be appreciated that the actuator system described herein is a preferred system only and other types of actuator systems may be used to change the configuration of the valve train assembly between the first and second configurations.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A valve train assembly for operating a first valve of a first cylinder of an internal combustion engine, the valve train assembly comprising:
a rotatable cam shaft including a cam arrangement,
where the cam arrangement is axially movable along the rotatable cam shaft so that the valve train assembly is selectively configurable in a first configuration and a second configuration,
wherein, in use, when the valve train assembly is in the first configuration, the first valve of the first cylinder is operated in response to the first cam arrangement as the rotatable cam shaft rotates to provide a corresponding valve event in each of a plurality of successive cylinder cycles, and
wherein, in use, when the valve train assembly is in the second configuration, the first valve of the first cylinder is operated in response to the first cam arrangement as the rotatable cam shaft rotates to provide a corresponding valve event in every other cylinder cycle of a plurality of successive cylinder cycles.

2. The assembly of claim 1, wherein the rotatable cam shaft is arranged to rotate at ¼ of a rotation rate of a crank shaft of the internal combustion engine.

3. The assembly of claim 1, wherein the cam arrangement includes a first cam and a second cam,
wherein, in use, when the valve train assembly is in the first configuration, the first valve of the first cylinder is operated in response to the first earn as the rotatable cam shaft rotates to provide the corresponding valve event in each of the plurality of successive cylinder cycles, and
wherein, in use, when the valve train assembly is in the second configuration, the first valve of the first cylinder is operated in response to the second cam as the rotatable cam shaft rotates to provide the corresponding valve event in every other cylinder cycle of the plurality of successive cylinder cycles.

4. The assembly of claim 3, wherein the first cam includes a first lift lobe and a second lift lobe,
wherein, when the valve assembly is in the first configuration, the first and second lift lobes cause the corresponding valve event in each of the plurality of successive cylinder cycles,
wherein, which of the first and second lift lobes causes the corresponding valve event in a given cylinder cycle alternates from cylinder cycle to cylinder cycle.

5. The assembly of claim 1, further comprising:
an actuator arrangement Ford configured to axially move the cam arrangement along the rotatable cam shaft to selectively configure the valve train assembly in the first configuration and the second configuration.

6. The assembly of claim 5, wherein the actuator arrangement includes a first actuator rod arranged co-axially with the rotatable earn shaft and drivable axially back and forth between first and second positions to push the cam arrangement along the rotatable cam shaft to configure the valve train assembly in the first configuration and the second configuration.

7. The assembly of claim 6, wherein the first actuator rod is arranged inside the rotatable cam shaft camshaft.

8. The assembly of claim 7, wherein the first actuator rod includes a first contact surface, which, following the first actuator rod being driven from the first position to the second position, causes the cam arrangement to be moved so that the valve train assembly is configured into the second configuration, and
wherein the first actuator rod includes a second contact surface, which, following the first actuator rod being driven from the second position to the first position, causes the cam arrangement to be moved so that the valve train assembly is configured into the first configuration.

9. The assembly of claim 8 wherein the cam arrangement includes a first member that extends through a first guide groove defined by the rotatable cam shaft into an inner bore of the rotatable cam shaft,
wherein the first contact surface pushes on the first member, following the first actuator rod being driven from the first position to the second position, to cause the cam arrangement to be moved so that the valve train assembly is configured into the second configuration, and
wherein the second contact surface pushes on the first member, following the first actuator rod being driven from the second position to the first position, to cause the cam arrangement to be moved so that the valve, train assembly is configured into the first configuration.

10. The assembly of claim 8, wherein the first member is arranged to inhibit relative rotation between the cam arrangement and the rotatable cam shaft.

11. The assembly of claim 5, wherein the cam arrangement includes an axial positioning pin,
wherein the rotatable cam shaft includes a first formation and a second formation,
wherein, when the valve train assembly is in the first configuration, the positioning pin engages the first formation, and
wherein, when the valve train assembly is in the second configuration, the positioning pin engages the second formation.

12. The assembly of claim 1, wherein the valve train assembly is configured to operate a respective first valve of each of a plurality of cylinders of the internal combustion engine,
wherein the rotatable cam shaft includes a plurality of cam arrangements, one for each cylinder; and wherein,
wherein each cam arrangement is axially movable along the rotatable cam shaft so that the valve train assembly is selectively configurable in the first configuration and the second configuration
wherein, in use, when the rotatable cam shaft is rotating, and when the valve train assembly is in the first configuration, the first valve of each cylinder is operated in response to a particular cam arrangement for that cylinder as the rotatable cam shaft rotates to provide a corresponding valve event in each of a plurality of successive cylinder cycles of that cylinder, and
wherein in use, when the rotatable cam shaft is rotating, and when the valve train assembly is in the second configuration, the first valve of each cylinder is operated in response to the particular cam arrangement for that cylinder as the rotatable cam shaft rotates to provide a corresponding valve event in every other cylinder cycle of a plurality of successive cylinder cycles of that cylinder.

13. The assembly of claim 12, wherein the plurality of cylinders includes a particular firing order sequence, and
wherein the cam arrangement for a given cylinder is configured to operate a valve of that cylinder appropriately for a position of that cylinder in the firing order sequence.

14. The assembly of claim 13, wherein there are 3 cylinders.

15. The assembly of claim 14, wherein, in use, the firing order sequence of the cylinders is a 1-2-3 sequence,
wherein, when in the second configuration, a repeating sequence for the three cylinders in combination is 1(active)-2(inactive)-3(active)-1(inactive)-2(active)-3(inactive),
wherein (active) indicates an active cylinder cycle,
wherein (inactive) indicates an inactive cylinder cycle, and
wherein, for a given cylinder, a corresponding valve event occurs in active cylinder cycles but not inactive cylinder cycles.
